(19) United States
(12) Patent Application Publication
(10) Pub. No.: US 2007/0291822 A1
(43) Pub. Date: Dec. 20, 2007

(54) RADIO COMMUNICATION SYSTEM

(75) Inventors: W. Gary Staley, Parkville, MO (US); Leslie R. Pingel, Excelsior Springs, MO (US); Benjamin J. Gray, Kansas City, MO (US); E. Dale May, Mission, KS (US); Franklin B. Parks, Overland Park, KS (US); Philip A. Staley, Parkville, MO (US); Rick A. Zerbs, Leawood, KS (US); Christopher H. Leonard, Kansas City, MO (US)

Correspondence Address: HOVEY WILLIAMS LLP, 2405 GRAND BLVD., SUITE 400, KANSAS CITY, MO, 64108, US

(73) Assignee: TriSquare Communication, Inc., Kansas City, MO (US)

(21) Appl. No.: 11/759,306

(22) Filed: Jun. 7, 2007

Related U.S. Application Data
(60) Provisional application No. 60/805,110, filed on Jun. 19, 2006.

(51) Int. Cl. H04B 1/00

(52) U.S. Cl. 375/132

(57) ABSTRACT

A radio communication system operable to efficiently generate a frequency hopping sequence for radio communication and/or accurately provide system synchronization using a cyclic code. The radio communication system may employ a frequency hopping method that generally comprises acquiring a seed value, identifying a channel number matrix position utilizing at least a portion of the seed value, identifying a radio channel corresponding to the matrix position, and transmitting or receiving a signal at a frequency corresponding to the identified radio channel.

### RELATED APPLICATION

The present non-provisional application claims the benefit of U.S. Provisional Application No. 60/805,110, entitled “FREQUENCY HOPPING SPREAD SPECTRUM SYSTEM,” filed Jun. 19, 2006. The identified provisional application is incorporated herein by specific reference.

### BACKGROUND

1. Field

Embodiments of the present invention relate to radio communication. More particularly, various embodiments of the invention provide methods and apparatuses operable to efficiently generate a frequency hopping sequence for radio communication and/or accurately provide system synchronization using a cyclic code.

2. Description of the Related Art

Radio communication systems often employ frequency hopping spread spectrum (FHSS) and other frequency hopping methods to enable a plurality of radio devices to communicate with limited interference. Unfortunately, FHSS radio systems typically require entire hopping sequences to be retained within memory, thereby increasing device complexity and limiting the number of available hopping sequences. Consequently, FHSS and other frequency hopping methods are often limited by the memory capabilities of utilized radio devices, employ synchronization techniques that inordinately delay initial communication in comparison with single channel radios, and/or require the utilization of precise time bases in both transmitting and receiving radios.

### SUMMARY

Embodiments of the present invention solve the above-described problems and provide a distinct advance in the art of radio communication. More particularly, various embodiments of the invention provide methods and apparatuses operable to efficiently generate a frequency hopping sequence for radio communication and/or accurately provide system synchronization using a cyclic code.

In some embodiments, the frequency hopping method may generally include: acquiring a seed value; identifying a channel number matrix position utilizing at least a portion of the seed value; identifying a radio channel corresponding to the matrix position; and transmitting or receiving a signal at a frequency corresponding to the identified radio channel.

The frequency hopping method may additionally or alternatively include: identifying a radio channel; acquiring a seed value; selecting a cyclic code utilizing at least a portion of the seed value; receiving a signal at a frequency corresponding to the identified radio channel; and authenticating the received signal utilizing the selected cyclic code.

It is to be understood that both the foregoing general description and the following detailed description are exemplary and explanatory only and are not necessarily restrictive of the invention claimed. The accompanying drawings, which are incorporated in and constitute a part of the specification, illustrate embodiments of the invention and together with the general description, serve to explain the principles of the invention.

### BRIEF DESCRIPTION OF THE DRAWING FIGURES

Various embodiments of the present invention are described in detail below with reference to the attached drawing figures, wherein:

FIG. 1 is a block diagram illustrating a plurality of radios configured in accordance with various embodiments of the present invention;

FIG. 2 is a block diagram illustrating some of the components of one of the radios illustrated in FIG. 1;

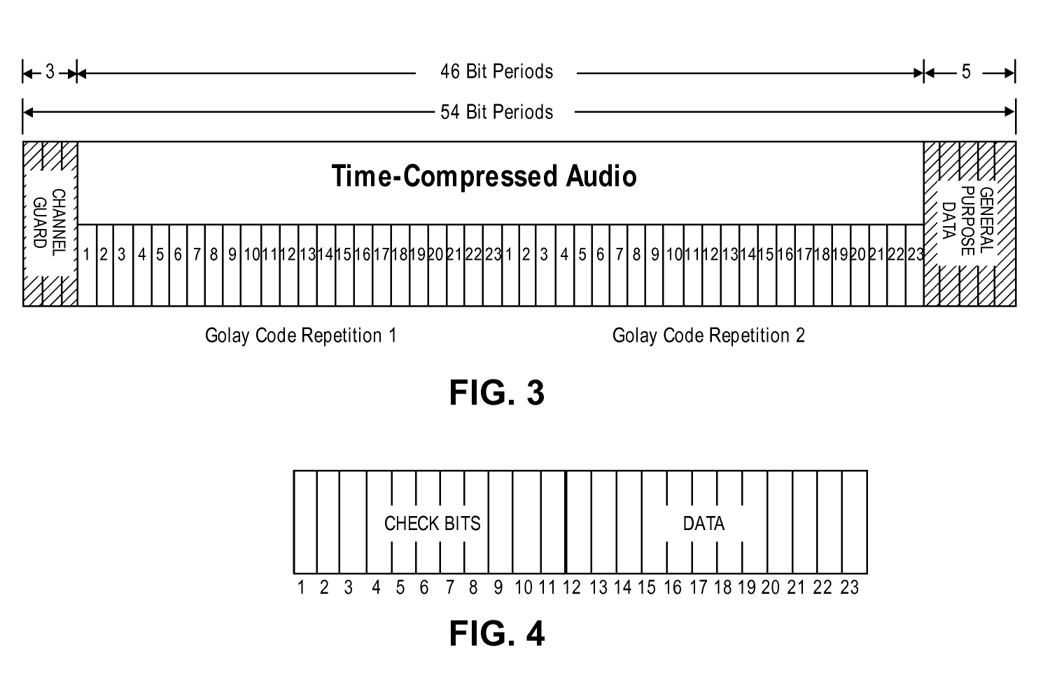

FIG. 3 is an exemplary signal frame format that may be utilized by various embodiments of the present invention;

FIG. 4 is an exemplary cyclic code format that may be utilized by various embodiments of the present invention;

FIG. 5 is an exemplary sequentially-ordered channel number matrix;

FIG. 6 is an exemplary randomly-ordered channel number matrix, the channel number matrix indicating an exemplary hopping sequence operable to be employed by various embodiments of the present invention; and

FIG. 7 is a block diagram showing some of the steps that may be performed by various embodiments of the present invention.

The drawing figures do not limit the present invention to the specific embodiments disclosed and described herein. The drawings are not necessarily to scale, emphasis instead being placed upon clearly illustrating various embodiments of the invention.

### DETAILED DESCRIPTION

The following detailed description of various embodiments of the invention references the accompanying drawings which illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

Various embodiments of the present invention provide a radio communication system 10 including a plurality of radios 12. As is discussed in more detail below, one or more of the radios 12 may be operable to generate a frequency hopping sequence for radio communication and/or accurately provide system synchronization using a cyclic code.

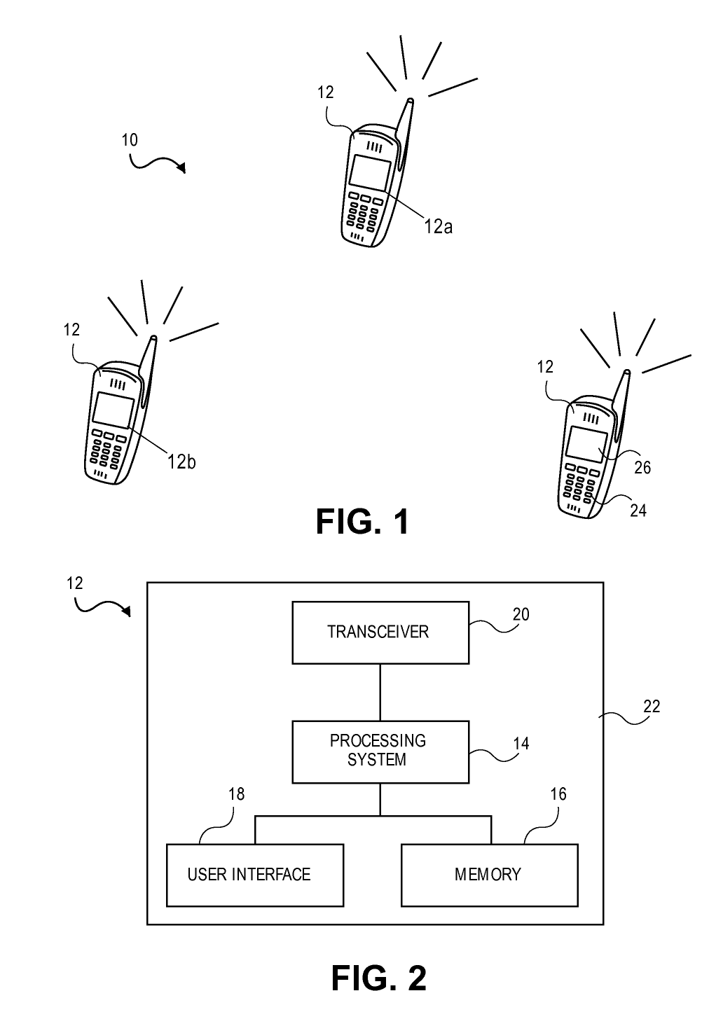

Each radio 12 may include a processing system 14, a memory 16, a user interface 18, and/or a transceiver 20. The processing system 14, memory 16, user interface 18, and transceiver 20 may be housed within a common housing 22, as is shown in FIG. 1, or disposed within two or more discrete housings. Further, in some embodiments, certain elements of each radio 12 may be integral, such as the processing system 14 and transceiver 20. The various radio 12 elements may be interconnected utilizing wired and/or wireless connections to facilitate the exchange of data and information. In some embodiments, one or more of the radios 12 may be configured in a similar manner to a conventional two-way frequency-hopping radio. However, each radio 12 may be configured in any manner to perform any combination of the functions discussed herein.

The processing system 14 is generally operable to control the functionality of various radio 12 elements such as the transceiver 20. The processing system 14 may be adapted to acquire information from the user interface 18 and/or memory 16 and process the acquired information as is discussed in more detail below. The processing system 14 may include any element or combination of elements operable to provide any of the various processing and control functions discussed herein. In some embodiments, the processing system 14 may include a microcontroller, microprocessor, programmable logic device, digital signal processor, cyclic code encoders and decoders, application specific integrated circuit, discrete analog and digital logic components, computing devices, digital-to-analog converters, analog-to-digital converters, distributed computing devices and networks, combinations thereof, and the like.

The memory 16 may include any computer-readable memory or combination of computer-readable memories operable to store data for use by the processing system 14 and/or transceiver 20. For instance, the memory 16 may be operable to store user inputs, seed values, configuration information, frequency hopping information, information corresponding to received and transmitted signals, computer programs operable to be executed by the processing system 14, combinations thereof, and the like. The memory 16 may also be adapted to be removed from the housing 22, such as in embodiments where the memory 16 includes a flash memory card.

The user interface 18 enables a user to provide one or more inputs for use by the processing system 14 and/or other radio 12 elements. The user interface 18 may also include additional elements to facilitate radio communication. For example, the user interface 18 may include one or more microphones for detecting user speech and one or more speakers for audibly presenting received radio communications to the user.

In some embodiments, as shown in FIG. 1, the user interface 18 may include a keypad 24 including a plurality of functionable inputs. However, the user interface 18 may be additionally or alternatively adapted to receive inputs from the user utilizing other interface elements such as a touch-screen display, software defined keys, a microphone with associated voice recognition capabilities, switches, latches, movement and orientation sensors, combinations thereof, and the like. The user interface 18 may also include a display 26 to visually provide information to the user. The display 26 may include the touch-screen display discussed above or be a generally conventional display, such as a liquid-crystal display.

The user interface 18 may provide wired and/or wireless connections discrete from the reception and transmission capabilities of the transceiver 20. Thus, in some embodiments the user interface 18 may provide a serial interface, a parallel interface, a wired network interface such as an Ethernet interface, a USB interface, a cellular interface, a RFID interface, a short-range wireless interface, combinations thereof, and the like. Thus, the user interface 18 enables the processing system 14 to easily communicate with the user and/or external computing, memory, and network devices.

The transceiver 20 may include any element or combination of elements operable to transmit and/or receive a signal. In various embodiments, the transceiver 20 includes an antenna and associated signal processing circuitry to enable the transceiver 20 to transmit and/or receive signals corresponding to desired frequencies. The transceiver 20 can be adapted to transmit and receive signals utilizing a plurality of radio channels, where each radio channel corresponds to a unique frequency. As is discussed in more detail below, the transceiver 20 may be controlled by the processing system 14 to hop between various radio channels according to a frequency hopping sequence.

Each one of the radios 12 and its corresponding transceiver 20 may be configured as a receiver operable to receive signals, a transmitter operable to transmit signals, or a transceiver operable to transmit and receive signals. The transceiver 20 may include discrete receiving and transmitting elements such that it does not necessarily form an integral unit.

The transceiver 20 may also be configured to receive more than one signal simultaneously such as through the inclusion of a plurality of receiving elements. Additionally, the transceiver 20 may be configured to transmit more than one signal simultaneously such as through the inclusion of a plurality of transmitting elements. Further, the transceiver 20 may simultaneously transmit and receive a plurality of signals based on various control signals provided by the processing system 14.

The processing system 14 may be discrete from the transceiver 20 and other elements discussed herein. However, in some embodiments, the processing system 14 may be integral with the transceiver 20. For example, a single integrated circuit may embody both the transceiver 20 and processing system 14. Further, the functionality of the transceiver 20 and processing system 14 may also be distributed between several elements, such as between a plurality of integrated circuits or discrete digital and analog components.

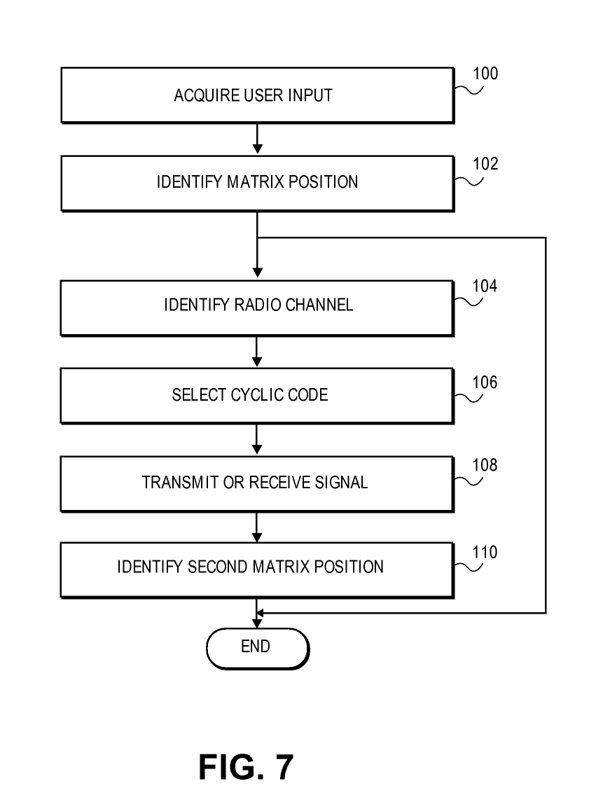

Various functions that may be performed by one or more of the radios 12 are illustrated in FIG. 7. For example, in some embodiments each radio 12 may: acquire a seed value, referenced at step 100; identify a matrix position, referenced at step 102; identify a radio channel, referenced at step 104; select a cyclic code, referenced at step 106; transmit and/or receive a signal, referenced at step 108; and identify a second matrix position, referenced at step 110.

Some of the steps illustrated in FIG. 7 may represent one or more code segments comprising at least a portion of a computer program executed by the processing system 14. Steps 100-110 may be performed in any order and are not limited to the specific order described herein. Steps 100-110 may be performed simultaneously or concurrently such that the steps are not necessarily sequential. Further, steps 100-110 are not each necessarily performed by all embodiments of the present invention.

As is discussed above in detail, each radio 12 may be operable to transmit and/or receive signals utilizing a plurality of radio channels. For exemplary purposes, a first radio 12a that transmits signals and a second radio 12b that receives signals transmitted by the first radio 12a are discussed below. However, any of the radios 12 may be configured to perform any of the functions discussed with reference to the radios 12a, 12b and embodiments of the present invention are not limited to the configuration of the radios 12a, 12b, discussed herein.

In step 100, a seed value is acquired. As is discussed in more detail below, the seed value may be provided by the user as a user input, generated by each radio 12 based on a user input or any other information, acquired by each radio 12 from external devices and systems, combinations thereof, and the like.

In various embodiments, radios 12 that are intended to communicate with each other may utilize the same seed value to establish a common frequency hopping sequence as is discussed in more detail below. Thus, for example, the first radio 12a and second radio 12b may be provided the same seed value using each radio's respective user interface 18 to enable the radios 12a, 12b to communicate with the same frequency hopping sequence. Any number of radios 12 may be provided the same seed value to enable communication between the radios 12.

The seed value utilized by the radios 12 preferably represents a unique value that is unlikely to be accidentally duplicated by other users and radios. Thus, the seed value is preferably sufficient in length or complexity to reduce the probability that the same seed value will be coincidentally utilized by unrelated users and radios. In some embodiments, the seed value is at least a four-digit number and may comprise a ten-digit number. Utilization of a ten-digit number provides user convenience and uniqueness by allowing the user input to correspond to the number of digits in a standard telephone number. Thus, one of the users may select a telephone number, such as the user's own telephone number or a number corresponding to an organization associated with both users, and inform the other user of the selection. Both users may then input the same telephone number to the radios 12a, 12b to ensure proper hopping compatibility, as is discussed in more detail below. In embodiments where the user input is a number, the keypad 24 associated with the user interface 18 may be functioned to input the number. However, the user interface 18 may be functioned in any manner to input numerical and non-numerical inputs.

In some embodiments, the first radio 12a and second radio 12b may communicate with each other utilizing various wired or wireless protocols to exchange and/or generate the seed value. For example, the keypad 24 associated with the first radio 12a may be functioned to input the seed value, or an intermediate value utilized to calculate the seed value, and the first radio 12a may share the seed value with the second radio 12b through a wired or wireless connection. However, as discussed above, the user interface 18 associated with each radio 12a, 12b may be independently functioned to generate the seed value for each radio 12a, 12b.

In some embodiments, each radio 12a, 12b may initially be provided with a different user input and the processing system 14 associated with each radio 12a, 12b may correlate the provided user input to a seed value common to both radios 12a, 12b. For example, each user may be assigned a unique password which is associated with the same seed value for use in generating frequency hopping sequences and cyclic codes.

Each radio 12a, 12b may additionally or alternatively automatically generate the seed value based upon information stored within its respective memory 16 and/or provided by the user. For example, the radios 12a, 12b may be preprogrammed with identifying information and each radio 12a, 12b may independently generate the seed value based on the stored identifying information. Further, in some embodiments, the radios 12a, 12b may acquire the seed value from external devices without independently computing the seed value. For example, a charging unit may be provided that is adapted to charge a plurality of radios, including the radios 12a, 12b. The radios 12a, 12b may be operable to communicate with the charging unit when in proximity thereto to receive the seed value from the charging unit. Thus, a plurality of radios may be easily configured to use the same seed value by utilizing the radios in combination with the charging unit or any other device or system.

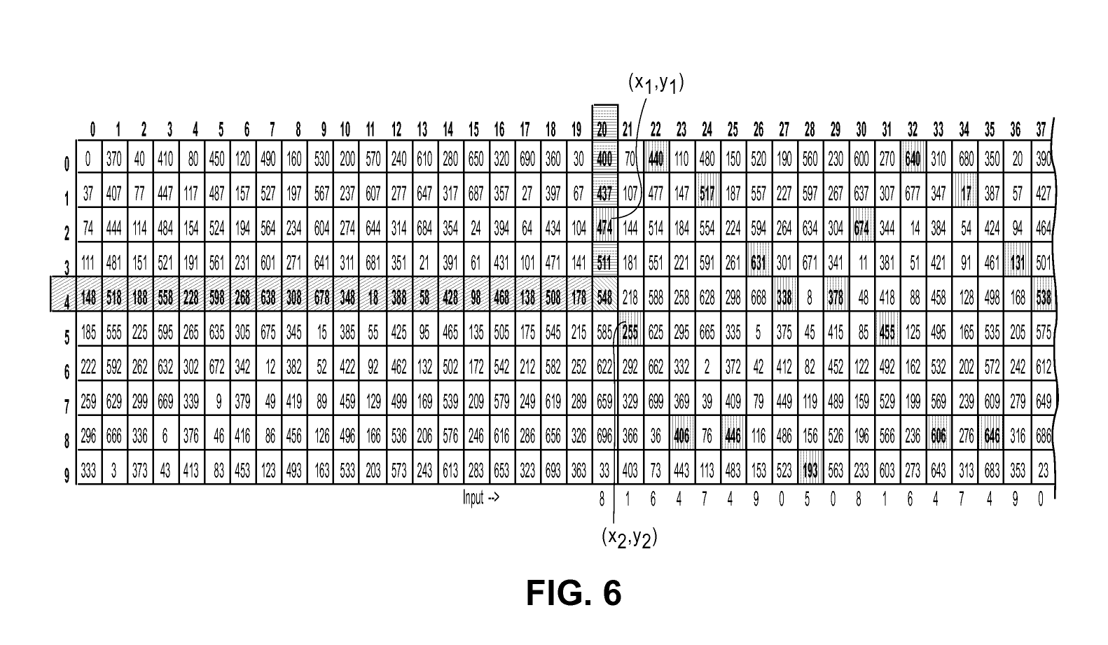

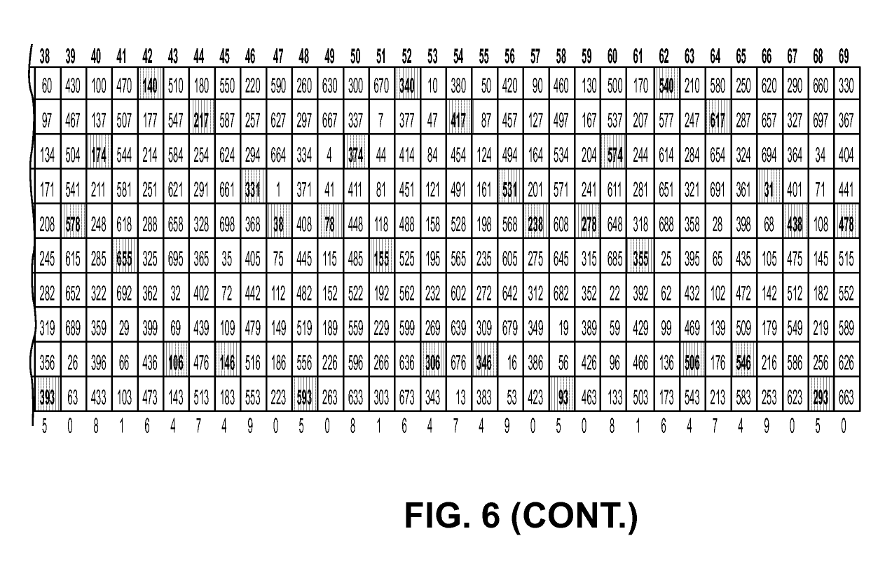

In step 102, the processing system 14 associated with each radio 12a, 12b identifies a channel number matrix position based on at least a portion of the seed value. Referring to FIGS. 5-6, each channel operable to be utilized by the radios 12a, 12b may be associated with a matrix such that at least one channel is associated with every matrix position. Each channel is preferably associated with a unique frequency such that no two channels correspond to the same frequency.

The channels may be distributed across a frequency range suitable for use in radio communications. In some embodiments, the channels are within the 900 MHz range, such as between about 906.275 MHz and 923.75 MHz. The particular frequency ranges associated with the channels will depend on the number of channels and the gap between each channel. For example, in some embodiments the radios 12a, 12b may be operable to employ seven-hundred channels with a 25 kHz step between each channel. Thus, in such embodiments, the frequency associated with any channel is given by:

f_{c}=f₀+sC (1),

where C is the channel number, f₀ is the lower bound of the frequency range, s is the step between channels, and f_{c} is the frequency associated with channel C. So, in the above example where f₀ equals 906.275 MHz and s is 25 kHz, the frequency associated with channel 100 may be 908.775 MHz.

However, the radios 12a, 12b may employ any number of channels corresponding to any number of frequencies. For example, the channels may additionally or alternatively correspond to family radio service (FRS) frequencies, general mobile radio service (GMRS) frequencies, citizens band (CB) frequencies, various FCC-approved cordless phone frequencies between 1.7 MHz and 5.8 GHz, combinations thereof, and the like. Similarly, the step between each channel may correspond to any static or dynamic frequency. Preferably, the frequencies corresponding to each channel are spaced sufficiently apart such that when fully modulated they introduce insignificant power into a system receiver bandwidth tuned to an adjacent frequency.

As shown in FIGS. 5-6, the matrix to which the channel number matrix position corresponds may be a two-dimensional matrix having x and y dimensions such that the matrix position identified in step 102 represents a x, y matrix position. The product of x and y preferably equals the total number of channels N operable to be utilized by the radios 12a, 12b. Thus, in some embodiments, a channel N_{x,y} is associated with every x and y position. However, in other embodiments, no channels or more than one channel may be associated with one or more matrix positions.

The processing system 14 associated with each radio 12a, 12b may identify the channel number matrix position by identifying a portion of the seed value and/or performing a mathematical operation on at least a portion of the seed value. For example, the processing system 14 may use a portion of the seed value as the x and/or y components of the matrix position. The processing system 14 may also perform mathematical operations on portions of the seed value, such as by summing, dividing, and/or multiplying portions of the seed value to identify x and y. For example, the processing system 14 may add digits of the seed value together to compute x. In embodiments where the seed value is non-numeric, the processing system 14 may identify x and y by converting the seed value to a numeric format or by utilizing a numeric base corresponding to the utilized seed value.

In various embodiments, the matrix position is identified in a manner that limits interference with other similarly-configured frequency hopping radios. Specifically, the x and y components of the matrix position may be identified in a manner that limits the probability of other radios 12 identifying the same series of matrix positions with a different seed value. Consequently, embodiments of the present invention limit interference between radios 12 that are provided with different seed values.

In embodiments where the seed value corresponds to a number having at least four digits, or where the seed value can be used to generate a number having at least four digits, the processing system 14 associated with each radio 12a, 12b may identify the matrix position utilizing—

$$( {x}_{1} , {y}_{1} ) = ( {I}_{L 4} mod \frac{N}{R} , ( {y}_{0} + {I}_{MSD} ) mod R ) , \qquad ( 2 )$$

where (x₁,y₁) is the first matrix position identified by each radio 12a, 12b, I_{L4} is the least four significant digits of the seed value, N is the number of radio channels, R is the number of rows represented by the channel number matrix, I_{MSD} is the most significant digit of the seed value, and y₀ is an initial row position given by the sum of all digits of the seed value modulo R.

In the example illustrated in FIG. 6, where the seed value corresponds to the number 8164749050, N is 700, and R is 10; (x₁,y₁) equals the matrix position (20, 2). Utilization of equation (2) to identify the matrix position may be desirable in some embodiments as it limits interference by reducing the probability that radios 12 utilizing seed values different than those provided to the radios 12a, 12b in step 100 will start at and continue to utilize the same matrix positions as the radios 12a, 12b.

In embodiments where each frequency hopping sequence includes fifty channels and equation (2) is utilized to select the first matrix position, any user in proximity of 10,000 other users would only expect an interference rate of 1.45%, or one interference event per 28 seconds, on average. Consequently, embodiments of the present invention are ideal for usage in locations with a high population density, where traditional FRS or other single channel radios experience heavy interference.

As should be appreciated, embodiments of the present invention are not limited to identifying matrix positions utilizing equation (2). As is discussed above, the processing system 14 associated with each radio 12a, 12b may identify the matrix position utilizing portions of the seed value in any manner. The matrix position identified by each processing system 14 in step 102 may be stored by each radio 12a, 12b within the memory 16, presented on the display 26, provided to other devices or systems through the user interface 18, transmitted by the transceiver 20, combinations thereof, and the like.

In step 104, the processing system 14 associated with each radio 12a, 12b identifies a channel corresponding to the matrix position identified in step 102. In some embodiments, each radio 12a, 12b may include within its memory 16 a database or table that represents the entire matrix associated with the matrix position. For example, the example matrix of FIG. 5 and/or FIG. 6 may be stored within the memory 16 of each radio 12a, 12b to allow the channel corresponding to each matrix position to be identified by utilizing a look-up table or the like.

In some embodiments, as shown in FIG. 5, the matrix may represent all channels in sequential order. In other embodiments, as shown in FIG. 6, a sequentially ordered matrix may be randomized to further limit signal interference. For example, each channel represented by the sequentially ordered matrix may be multiplied by a randomizing value P to form a non-sequential matrix. The randomizing value P may be any number or function and in some embodiments corresponds to a prime number. For example, to generate the matrix of FIG. 6, each channel represented by the matrix of FIG. 5 may be multiplied by the prime number 37 modulo the total number of channels N. Utilization of a prime number as the randomizing value prevents the formation of ramping frequency hopping sequences.

In some embodiments, the radios 12a, 12b may conserve memory and system resources by not storing complete matrixes within their respective memories 16. As each position within a matrix may be represented mathematically, the processing system 14 associated with each radio 12a, 12b may identify the channel corresponding to the matrix position mathematically without requiring the storage of the entire matrix. For example, if the matrix sequentially represents channels, the channel associated with any matrix position may be given by—

N_{x,y}=((xR)+y) (3),

where N_{x,y} is the radio channel associated with matrix position (x, y) and R is the number of rows represented by the channel number matrix.

In embodiments where the matrix is a randomized matrix as discussed above, the channel associated with any matrix position may given by—

N_{x,y}=((xR)+y)P mod N (4),

where N_{x,y} is the radio channel associated with matrix position (x, y), R is the number of rows represented by the channel number matrix, P is a randomizing value, and N is the number of channels.

Thus, utilization of equations (3) and/or (4) enables the processing system 14 associated with each radio 12a, 12b to identify the channel associated with any matrix position without storing the entire matrix and all associated channels within memory. The particular channel or channels identified utilizing equations (3) and/or (4) may be stored by each radio 12a, 12b within its memory 16, presented on its display 26, provided to other devices or systems through the user interface 18, transmitted by the transceiver 20, combinations thereof, and the like.

In step 106, the processing system 14 associated with each radio 12a, 12b selects a cyclic code. In various embodiments, the cyclic code selected by each radio 12a, 12b is the same cyclic code to facilitate signal authentication and system synchronization, as is discussed in more detail below. In various embodiments, each processing system 14 selects the cyclic code based on at least a portion of the seed value. Consequently, the seed value may be employed to enable each radio 12a, 12b to select the same matrix position and cyclic code to limit interference with other radios 12 having different seed values.

The cyclic code utilized by embodiments of the present invention may be any code that corresponds at least partially to the seed value. A Golay code, such as the (23,12) Golay code, may be employed by embodiments of the present invention. Utilizing at least a portion of the seed value to generate the cyclic code helps to ensure that the same code is assigned only to cyclic code sequences that will generally be divergent.

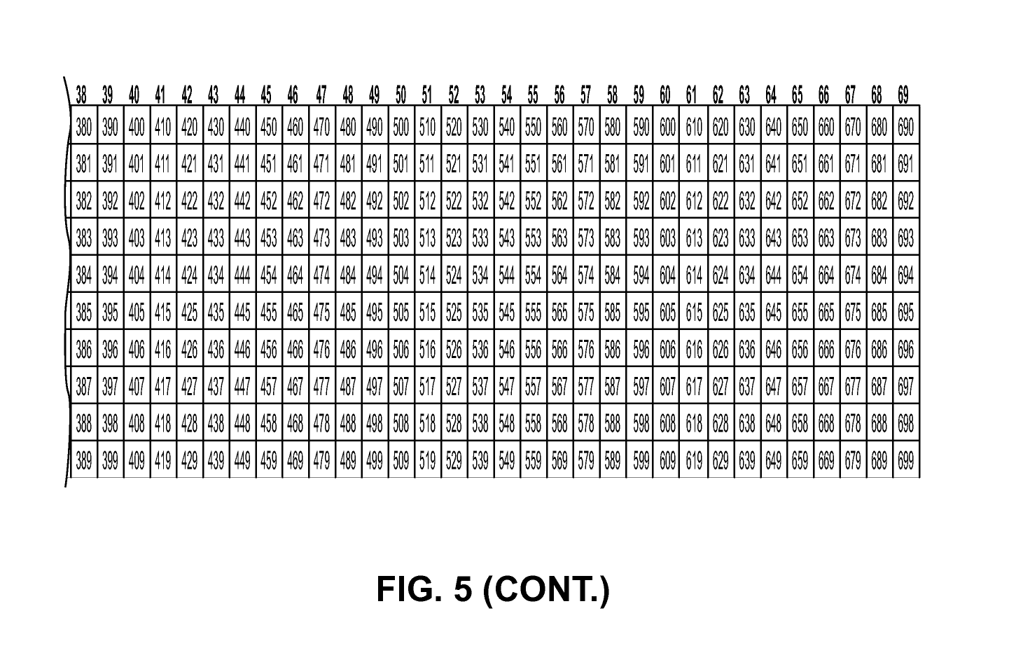

As shown in FIG. 4, the (23,12) Golay code may include twelve data bits and eleven check bits. The processing system 14 associated with each radio 12a, 12b may generate the data bits by utilizing the seed value. For example, any twelve bits of the seed value may be used as the twelve data bits. In some embodiments, the twelve data bits are generated by taking the four least-significant digits of the seed value modulo 2048 and appending a zero as the most significant bit to the resulting eleven-bit number to form the twelve data bits. If the result is zero, 2047 may be used.

The twelve data bits may be used by the processing system 14 associated with each radio 12a, 12b to generate the eleven check bits utilizing a software and/or hardware Golay encoder. The Golay encoder may include any known Golay encoding elements, processes, and/or methods. In some embodiments, the Golay encoder is used to generate a Golay polynomial and the twelve data bits are exclusive or'd with the Golay polynomial to generate the eleven check bits. However, the cyclic code, including the Golay code, may be generated in any manner using the seed value. Further, the cyclic code may correspond to any number of bits and is not limited to the exemplary twenty-three bit code discussed above.

The cyclic code identified by each processing system 14 in step 106 may be stored by each radio 12a, 12b within the memory 16, presented on the display 26, provided to other devices or systems through the user interface 18, transmitted by the transceiver 20, combinations thereof, and the like. In some embodiments, step 106 is not necessarily performed as signals may be transmitted and received by the radios 12 without the use of cyclic codes.

In step 108, the radios 12a, 12b may transmit and/or receive signals based on the radio channel identified in step 104. For example, the first radio 12a may identify the frequency of the identified radio channel utilizing equation (1) and transmit a signal at the identified frequency. The second radio 12b may similarly identify the frequency of the identified radio channel and receive a signal at the identified frequency. The signals transmitted and/or received by the radios 12a, 12b may be in any format and represent any type of data and information.

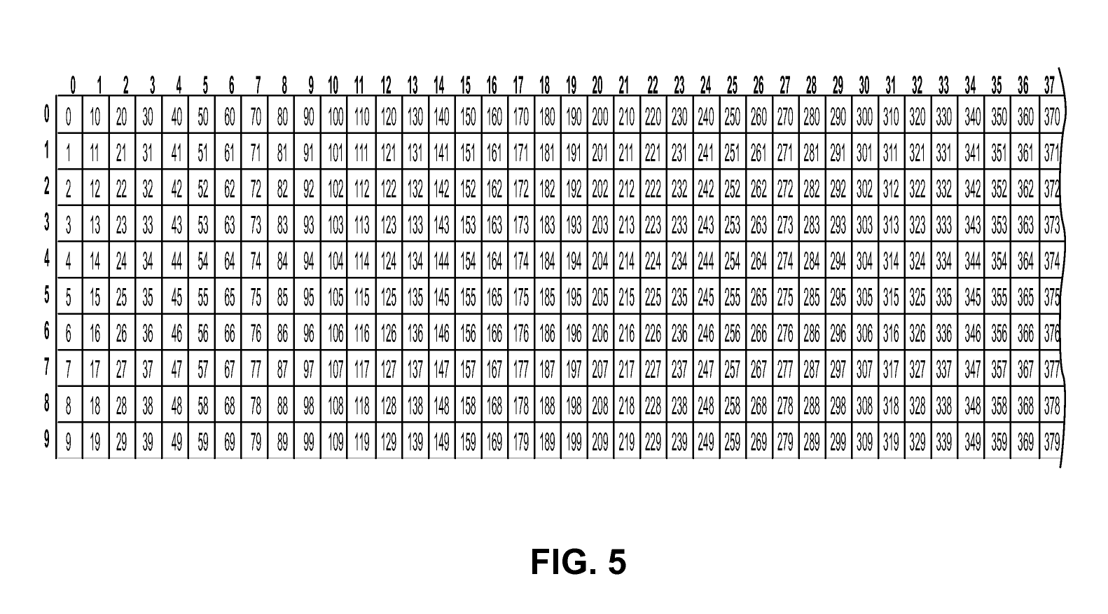

In some embodiments, the transmitted signal may be embodied as a frame, such as the exemplary frame illustrated in FIG. 3. The exemplary frame illustrated in FIG. 3 is represented by fifty-four frame bit periods. The duration of each frame and corresponding bit periods may be selected based on the timing of the bit duration of the cyclic code utilized by the radios 12a, 12b. However, the duration of the frame and corresponding bit periods may be determined in any manner.

In some embodiments each frame may represent a portion of a compressed audio signal. For example, the user interface 18 may detect user speech and the processing system 14 may compress at least a portion of the detected user speech for transmission in step 108. The processing system 14 associated with each radio 12a, 12b may compress and/or decompress audio signals in real-time to prevent undesirable communication delays.

To compress audio for transmission, the processing system 14 associated with each radio 12 may include an analog to digital converter (ADC) to convert received audio signals into a digital format. Similarly, to decompress audio for output, the processing system 14 associated with each radio 12 may include a digital to analog converter (DAC). The DAC may provide for a variable dynamic range output without reducing the signal to noise ratio. The processing system 14 of each radio 12 may control the dynamic range of the DAC output to provide electronic volume control and an audio compander function. The compander performs an amplitude compression function on the transmitter audio prior to modulation of the carrier and performs the inverse expansion function on the received audio. Use of the compander function minimizes the degradation of signal to noise when an originating signal, such as microphone audio, is transferred through a channel with less dynamic range capability than that of the originating signal.

In some embodiments, each frame may include forty-six frame bits of a time-compressed audio signal, with each frame bit period representing about 7.44 ms for a total frame time of about 401.76 ms. The processing system 14 may compress 401.76 ms of real time audio into 342.24 ms (forty-six frame bit periods). However, each frame may represent any number of frame bits having any frame bit period and embodiments of the present invention are not limited to the exemplary frame bit periods discussed herein.

In addition to representing time-compressed audio, each frame may also include frame bits representing lock time and general purpose data. For example, as shown in FIG. 3, the start of each frame may include three channel guard frame bits that do not represent data to enable receiving and transmitting radios sufficient time to transition between frequencies associated with different channels.

The plurality of general purpose data frame bits enable the transmission of data other than compressed audio. For example, the data field may be used for caller ID information, call waiting, conferencing, privacy and security information, transition notifications for transitions between all data and mixed data/audio frames, text messaging, remote control, contact and phone book information, radio and system configuration information, user and device status information, combinations thereof, and the like. Each frame may include any number of lock time and general purpose data frame bits and is not limited to the frame bit configuration illustrated in FIG. 3.

In embodiments employing the cyclic code discussed above in step 106, each frame may also include a sub-audible representation of the selected cyclic code. For example, as shown in FIG. 3, in embodiments where the (23, 12) Golay code is employed, two repetitions of the (23, 12) Golay code may be used, for a total of forty-six code frame bits, to correspond with time-compressed audio. As is discussed below, utilization of the cyclic code in combination with each transmitted frame facilitates system synchronization and authentication by allowing for continuous verification and updating by receiving radios 12 of frame position in time throughout each received frame.

Thus, in step 108, the first radio 12a may transmit a signal embodied by one frame. In other embodiments, the first radio 12a may transmit a plurality of signals embodied by a plurality of frames in step 108. As is discussed in more detail below, it is desirable in some embodiments to transmit only one frame per channel to limit the probability of signal interference.

In some embodiments, the first radio 12a may vary the power at which it transmits signals to provide a low power transmit mode to allow for very short distance transfer of information from one radio 12 to another. The low-power transmit mode may be utilized to transfer sensitive information, such as contact information and seed values, or to clone radios 12 over only short ranges.

In step 108, the second radio 12b may utilize its transceiver 20 to receive the signal and/or signals transmitted by the first radio 12a at the channel identified in step 104. The second radio 12b may periodically or continuously monitor the channel identified in step 104 until a signal is received. In some embodiments, the second radio 12b may be operable to function in a standby mode, where power is only periodically provided to its transceiver 20 to check for signals on the channel identified in step 104, thereby conserving power. As both radios 12a, 12b utilize the same seed value, the channel utilized by the second radio 12b in step 108 will be the same as the channel utilized by the first radio 12a in step 108. Thus, the first signal transmitted by the first radio 12a may be asynchronously transmitted for reception by the second radio 12b.

Upon reception of a transmitted signal, the processing system 14 associated with the second radio 12b identifies the timing, such as the frame bit periods, associated with the received signal. The processing system 14 associated with the second radio 12b may utilize a software and/or hardware phase lock loop (PLL) to track the clock period of the frame embodied by the received signal.

After identification of the timing of the received signal and locking on the received signal, the second radio 12b may place data corresponding to the received signal in a buffer or other portion of its memory 16. Utilizing the acquired timing information, the second radio 12b may identify the cyclic code included within the received frame and compare the identified cyclic code to the cyclic code selected in step 106. If the cyclic code selected in step 106 does not match the cyclic code represented by the frame, the second radio 12b may utilize the selected cyclic code and/or cyclic code polynomial to correct errors in the received frame and/or identify the received transmission as an interfering signal and ignore the remainder of the frame or otherwise suppress communication.

The second radio 12b may also utilize the cyclic code of the received frame to lock onto the frame and determine the current frame bit position within the frame. Thus, the signal transmitted by the first radio 12a establishes the timing employed by both radios 12a, 12b and the second radio 12b is not required to synchronize with the first radio 12a by utilizing an independent clock. As is discussed in more detail below, the second radio 12b may also utilize the frame lock established in step 108 to hop through channels without the use of an independent clock or a master synchronization system in the event that communication with the first radio 12a is temporarily lost.

The use of cyclic codes by the system 10 for authentication and synchronization ensures that an established communications link will not break down or lose accurate time tracking until well below the usable sensitivity of the system 10. A characteristic of the cyclic codes that is utilized by embodiments of the present invention is that the processing system 14 associated with each radio 12 may determine during the decode process which frame bit position the latest received frame bit represents in the particular code. The processing system 14 associated with each radio 12 may utilize this characteristic to establish and verify position timing within a frame of data on a bit by bit basis.

The processing system 14 associated with the second radio 12b may decompress received audio signals in real-time for audible output to the user to facilitate radio communication. The processing system 14 associated with the second radio 12b may also utilize non-audio data represented by the received signal, such as data represented by the general purpose data frame bits, for various functions and purposes. For example, as discussed above, the second radio 12b may present the identification of the transmitting user on the display 26 utilizing caller identification information represented by the general purpose data frame bits. The second radio 12b may also use non-audio data for call waiting purposes, such as where the second radio 12b is in communication with another radio when it receives the signal transmitted by the first radio 12a in step 108.

To prevent receiving radios 12 from generating an undesirable audible noise burst, such as a squelch tail, as the end of a transmission, transmitting radios, such as the first radio 12a, may include an end-of-transmission command within the frame that may be identified by receiving radios 12, such as the second radio 12b, as a command to mute audio output. Upon reception of the end-of-transmission command, receiving radios 12 may also play an audible roger beep to confirm to users that a transmission has ended and it is therefore appropriate to respond.

In step 110, the processing system 14 associated with each radio 12a, 12b identifies a second channel number matrix position utilizing at least a portion of the seed value. To limit interference, the second matrix position is preferably determined utilizing a portion of the seed value different than the portion used to identify the first matrix position. In some embodiments, the processing system 14 associated with each radio 12a, 12b may identify the second matrix position utilizing the first matrix position and at least a portion of the seed value.

The processing system 14 associated with each radio 12a, 12b may identify the second channel number matrix position by identifying a portion of the seed value and/or by performing a mathematical operation on at least a portion of the seed value. For example, the processing system 14 may use a portion of the seed value as the x and/or y components of the second matrix position. The processing system 14 may also perform mathematical operations on portions of the seed value, such as by summing, dividing, and/or multiplying portions of the seed value to identify x and y. For example, the processing system 14 may add digits of the seed value to compute x. In embodiments where the seed value is non-numeric, the processing system 14 may identify x and y by converting the seed value to a numeric format or by utilizing a numeric base corresponding to the utilized seed value.

In embodiments where the seed value corresponds to a number having at least four digits, or where the seed value can be used to generate a number having at least four digits, the processing system 14 associated with each radio 12a, 12b may identify the second matrix position utilizing—

$$( {x}_{2} , {y}_{2} ) = ( ( {x}_{1} + 1 ) mod \frac{N}{R} , ( {y}_{0} + {I}_{2 MSD} ) mod R ) , \qquad ( 5 )$$

where (x₂,y₂) is the second matrix position and I_{2MSD} is the second most significant digit of the seed value. Thus, in the example illustrated in FIG. 6, where x₁ is 20, y₀ is 4, N is 700, R is 10, and I_{2MSD} is 1, X₂ is 21 and y₂is 5.

Utilization of equation (5) to identify the second matrix position may be desirable in some embodiments as it limits interference by reducing the probability that radios 12 utilizing seed values different than those utilized by the radios 12a, 12b will arrive at the same second matrix position from the first matrix position and continue to interfere with the radios 12a, 12b.

As should be appreciated, embodiments of the present invention are not limited to identifying second matrix positions utilizing equation (5). As is discussed above, the processing system 14 associated with each radio 12a, 12b may identify the second matrix position utilizing portions of the seed value in any manner. The second matrix position identified by each processing system 14 in step 102 may be stored by each radio 12a, 12b within the memory 16, presented on the display 26, provided to other devices or systems through the user interface 18, transmitted by the transceiver 20, combinations thereof, and the like.

After identification of the second matrix position in step 110, steps 104 and 108 may be repeated to identify a second radio channel associated with the second matrix position and transmit and/or receive signals associated with the second radio channel. In some embodiments, step 106 may be repeated to select a second cyclic code based on the second matrix position. However, the selected cyclic code may remain the same for all matrix positions corresponding to the same seed value.

Thus, after the first matrix position is identified in step 102, each radio may hop through a plurality of the radio channels by identifying matrix positions with—

$$( {x}_{K} , {y}_{K} ) = ( ( {x}_{K - 1} + 1 ) mod \frac{N}{R} , ( {y}_{0} + {I}_{KMSD} ) mod R ) , \qquad ( 6 )$$

where (x_{K},y_{K}) is the Kth matrix position and I_{KMSD} is the Kth most significant digit of the seed value. However, any equation or method may be used to identify the hopping sequence employed by the radios 12 and embodiments of the present invention are not limited to the use of equations (1)-(6). In some embodiments the radios 12 are configured to hop through a sequence of fifty channels before repeating. However, hopping sequences of any length may be employed by embodiments of the present invention.

Further, each radio 12a, 12b may employ the timing identified in step 108 utilizing the time base of the cyclic code and the identified bit frame position to determine when to hop to a channel associated with an identified matrix position. For example, utilizing the cyclic code, the second radio 12a may determine a frame bit position within any frame transmitted according to any matrix position or channel. In embodiments where each frame includes fifty-four frame bits represented by fifty-four frame bit periods, the second radio 12a may identify the next matrix position utilizing equation (6) or another method and hop to a new channel at the end of the fifty-four frame bit periods. Once each radio 12a, 12b has decoded the cyclic code and determined its position within a frame, each radio 12a, 12b may perform continuous position verification, even across a plurality of frames, with each new bit received of the cyclic code.

In various embodiments, each associated radio synchronously hops through the channels after the first transmission of step 108 according to a dwell time. The radios 12 associated with a hopping sequence may hop through various channels based on the timing established utilizing the cyclic code independent of any transmissions. The dwell time indicates the period of time at which the radios 12 will hop through channels before reverting to the originally-identified channel. Once the dwell time has been exceeded, each radio 12 associated with the hopping sequence will begin to monitor the originally-identified channel for new transmissions.

In some embodiments, radios 12 may be configured to periodically monitor both the originally-identified channel and the channel associated with the identified hopping sequence. If a new transmission is identified on the originally-identified channel within the dwell time, the general purpose frame bits associated with the new transmission may be utilized to enable call waiting functionality. For example, if a transmission is detected on the originally-identified channel while the hopping sequence indicates that another channel should be used, the radio 12 detecting the transmission may present an audible or visual alert to allow the user of the radio 12 to listen to and/or follow the new transmission. This capability also allows for out of synch communications to be tracked and locked onto.

In some embodiments, each radio 12 may be configured to follow a plurality of hopping sequences to enable communication with different groups of radio devices. For example, the first radio 12a may communicate with the second radio 12b utilizing a first hopping sequence and a third radio utilizing a second hopping sequence, where the second radio 12b and third radio do not directly communicate with each other.

As each radio 12 hops through channels according to identified matrix positions, the radios 12 may use the cyclic code to authenticate received signals. For example, in the event two radios 12 having different seed values arrive at the same channel at the same time, receiving radios 12 may identify the cyclic code to correct for errors and identify interfering signals. If a radio identifies an interfering signal on a channel, it may mute audio to avoid confusing its user.

Since all radios 12 programmed with the same seed value have prior knowledge of both the hopping sequence and cyclic code assigned to any transmission of interest, receiving radios 12 may un-mute audio to facilitate rapid communication even prior to authenticating a received signal. For example, when information is being received that fits the data structure of the anticipated frame and the correct timing of the expected cyclic code, each radio 12 may examine the received data pattern to determine if it matches with at least a portion of the cyclic code, and if a match exists, audio and other information may be output to the user as it is highly likely that the received frame is authentic. If the received frame is found to be not authentic, audio and other information may be quickly muted again. Such a configuration enables the radios 12 to rapidly communicate without the unreasonable delays often present in conventional FHSS systems.

Each hopping sequence may be effectively tagged by each radio 12 with alphanumeric identification to be used as an authorization gate for the sequence. Communications on a sequence can be specified as private (one-to-one), fully authorized for an entire group or authorized only for certain members of a group (subgroup). A participant in a communications session may temporarily leave the session without losing track of session timing so that it may be rejoined at a later time (on hold). This capability allows for both the receipt of another private incoming call (call waiting) or the initiation of an independent private or group outgoing call. The two active sessions may be alternatively selected or the two sessions may be joined (conferenced). Conferencing is accomplished by transmitting to one session the appropriate hopping sequence, position (channel in sequence) and relative timing offset (frame position) of the other session to be joined.

In some embodiments, radios 12 may initially monitor only the first channel identified in step 104 for initial transmissions. To limit the effect of interfering or jamming signals that may prevent synchronization and consequently cause a communications failure, the radios 12 may be configured to utilize various signal processing methods to examine received signals and information to determine if a received signal is valid, represents only non-periodic noise (i.e., a clear channel) or represents a lack of information (e.g., a dead carrier).

To examine received signals, the processing system 14 associated with each radio 12 may utilize a software and/or hardware PLL and a digitally controlled oscillator to identify if the relative phase error of an incoming signal has converged to a small predetermined value, which is indicative of potentially valid and non-interfering data. Each processing system 14 may also employ conventional interference-detection methods, such as by determining if received signals are of the proper format and frequency.

Based upon the examination of one or more received signals, each radio 12 may examine additional information received to validate the communication or move a channel ahead in the hopping sequence to avoid a jamming or interfering signal and ensure continuous and appropriate communication with similarly-configured radios 12. If non-periodic noise is detected, the radio 12 may stay on its current channel.

If one of the radios 12 has moved forward in the hopping sequence and the conditions that triggered the forward movement stop, the radio 12 may walk back to the first sequence channel in a two steps back, one step forward algorithm to prevent missing valid sessions that started after the radio 12 had previously left the first channel.

The signal processing methods utilized by the processing system 14 may also be adapted to prevent the generation of unnecessary loud outputs. For example, the processing system 14 associated with the each radio 12 may provide soft mute functionality to adjust the volume of audio outputs based on the amount of noise detected in a received signal.

The radio communication system 10 and radios 12 discussed herein may allow for simplex, half-duplex, TDD (time domain duplex) and FDD (frequency domain duplex) communications techniques for the transfer of voice and/or data utilizing the frames discussed above. In some embodiments, the radio communication system 10 is a PTT (push-to-talk) or VOX (voice operated transmission) half-duplex system, but other techniques can be employed to augment overall system functionality and applications. To provide for greater security, making it even more difficult for an accidental or intentional eavesdropper to listen to a private conversation, each radio 12 may be adapted to transmit signals according to one frequency hopping sequence and receive signals according to another frequency hopping sequence.

Various embodiments of the present invention enable one or more of the radios 12 to be configured as repeaters to repeat received signals and extend the effective range of transmitting radios. In some embodiments, receiving radios, such as the second radio 12b, may be manually configured to repeat signals received according to the hopping sequence defined by the seed value. Thus, for instance, the user may function the user interface 18 to configure the second radio 12b as a repeater.

A transmitting radio, such as the first radio 12a, may additionally or alternatively request that other radios, such as the second radio 12b, repeat received signals without requiring direct configuration by the user. For example, the first radio 12a may transmit a signal to the second radio 12b and the signal may include a request that the second radio 12b function as a repeater and retransmit information corresponding to at least a portion of the signal or any other received signal. The request may be included within the general purpose bits of the frame. The second radio 12b may identify the repeating request and retransmit the signal accordingly. Some embodiments of the present invention may employ TDD communication techniques and the frame structure discussed above to enable original and repeated signals to be properly synchronized.

It is believed that embodiments of the present invention and many of its attendant advantages will be understood by the foregoing description, and it will be apparent that various changes may be made in the form, construction and arrangement of the components thereof without departing from the scope and spirit of the invention or without sacrificing all of its material advantages. The form herein before described being merely an explanatory embodiment thereof, it is the intention of the following claims to encompass and include such changes.

What is claimed is:

1. A frequency hopping radio communication method comprising:
(a) selecting a cyclic code;
(b) receiving a signal at a frequency corresponding to a radio channel; and
(c) authenticating the received signal utilizing the selected cyclic code.

2. The method of claim 1, further including—
(d) synchronizing with a transmitting radio utilizing the received signal and the selected cyclic code.

3. The method of claim 2, wherein the received signal is embodied as a frame and (d) includes identifying a position within the frame utilizing the selected cyclic code.

4. The method of claim 2, wherein (d) includes utilizing the cyclic code to identify a time at which to receive another signal at another frequency corresponding to another radio channel.

5. The method of claim 1, wherein the cyclic code is a (23, 12) Golay code.

6. The method of claim 1, wherein the received signal includes a sub-audible representation of at least a portion of the selected cyclic code and the received signal is authenticated by comparing the cyclic code selected in (a) to the cyclic code represented by the received signal.

7. The method of claim 1, further including processing at least a portion of the received signal to identify a repeating request, and if the received signal includes the repeating request, retransmitting information corresponding to the received signal.

8. The method of claim 1, further including acquiring a seed value and selecting the cyclic code utilizing at least a portion of the seed value.

9. The method of claim 8, further including identifying a matrix position utilizing at least a portion of the seed value and identifying the radio channel based on the matrix position.

10. The method of claim 9, wherein the matrix position corresponds to a channel number matrix having a plurality of columns and rows and the matrix position is identified by—
$$( {x}_{1} , {y}_{1} ) = ( {I}_{L 4} mod \frac{N}{R} , ( {y}_{0} + {I}_{MSD} ) mod R ) ,$$
where (x₁,y₁) is the matrix position, I_{L4} is the least four significant digits of the seed value, N is the number of radio channels, R is the number of rows represented by the channel number matrix, IMSD is the most significant digit of the seed value, and y₀ is an initial row position given by the sum of all digits of the seed value modulo R.

11. The method of claim 9, wherein the radio channel is identified by—
Nₓ_{₁}_{,y}_{₁}=((x₁R)+y₁)P mod N,
where N_{x1,y1} is the radio channel associated with matrix position (x₁, y₁), R is the number of rows represented by the channel number matrix, N is the number of radio channels, and P is a randomizing value.

12. The method of claim 9, further including—
identifying a plurality of matrix positions by—
$$( {x}_{K} , {y}_{K} ) = ( ( {x}_{K - 1} + 1 ) mod \frac{N}{R} , ( {y}_{0} + {I}_{KMSD} ) mod R ) ,$$
where (xₖ,yₖ) is the Kth matrix position and I_{KMSD} is the Kth most significant digit of the seed value,
identifying radio channels corresponding to the identified matrix positions, and
receiving signals at frequencies corresponding to the radio channels.

13. A radio comprising:
a processing system operable to select a cyclic code; and
a transceiver coupled with the processing system and operable to receive a signal at a frequency corresponding to a radio channel,
the processing system being further operable to authenticate the received signal utilizing the selected cyclic code.

14. The radio of claim 13, the processing system being further operable to synchronize with a transmitting radio utilizing the received signal and the selected cyclic code.

15. The radio of claim 14, wherein the received signal is embodied as a frame and the processing system is operable to identify a position within the frame utilizing the selected cyclic code.

16. The radio of claim 14, wherein the processing system is operable to utilize the cyclic code to identify a time at which to receive another signal at another frequency corresponding to another radio channel.

17. The radio of claim 13, wherein the cyclic code is a (23,12) Golay code.

18. The radio of claim 13, wherein the received signal includes a sub-audible representation of at least a portion of the selected cyclic code and the processing system is operable to authenticate the received signal by comparing the selected cyclic code to the cyclic code represented by the received signal.

19. The radio of claim 13, wherein the processing system is further operable to process at least a portion of the received signal to identify a repeating request, and if the received signal includes the repeating request, prompt the transceiver to retransmit information corresponding to the received signal.

20. The radio of claim 13, wherein the processing system is further operable to acquire a seed value and select the cyclic code utilizing at least a portion of the seed value.

21. The radio of claim 20, wherein the processing system is operable to identify a matrix position utilizing at least a portion of the seed value and identify the radio channel based on the matrix position.

22. The radio of claim 21, wherein the matrix position corresponds to a channel number matrix having a plurality of columns and rows and the matrix position is identified by—
$$( {x}_{1} , {y}_{1} ) = ( {I}_{L 4} mod \frac{N}{R} , ( {y}_{0} + {I}_{MSD} ) mod R ) ,$$
where (x₁,y₁) is the matrix position, I_{L4} is the least four significant digits of the seed value, N is the number of radio channels, R is the number of rows represented by the channel number matrix, I_{MSD} is the most significant digit of the seed value, and y₀ is an initial row position given by the sum of all digits of the seed value modulo R.

23. The radio of claim 21, wherein the processing system identifies the radio channel by—
Nₓ_{₁}_{my}_{₁}=((x₁R)+y₁)P mod N,
where N_{x1,y1} is the radio channel associated with matrix position (x₁, y₁), R is the number of rows represented by the channel number matrix, N is the number of radio channels, and P is a randomizing value.

24. The radio of claim 21, wherein the processing system is further operable to identify a plurality of matrix positions by—
$$( {x}_{K} , {y}_{K} ) = ( ( {x}_{K - 1} + 1 ) mod \frac{N}{R} , ( {y}_{0} + {I}_{KMSD} ) mod R ) ,$$
where (xₖ,yₖ) is the Kth matrix position and I_{KMSD} is the Kth most significant digit of the seed value,
the processing system being further operable to identify radio channels corresponding to the identified matrix positions, and
the transceiver being further operable to receive signals at frequencies corresponding to the radio channels.

25. The radio of claim 20, further including a user interface operable to receive an input from a user, the processing system being coupled with the user interface and operable to utilize at least a portion of the user input as the seed value.

26. A radio comprising:
a processing system operable to—
acquire a seed value,
select a cyclic code utilizing at least a portion of the seed value,
identify a matrix position utilizing at least a portion of the seed value, and
identify a radio channel corresponding to the matrix position; and
a transceiver coupled with the processing system and operable to receive a signal at a frequency corresponding to the identified radio channel,
the processing system being further operable to authenticate the received signal utilizing the selected cyclic code and synchronize with a transmitting radio utilizing the received signal and the selected cyclic code.

27. The radio of claim 26, wherein the processing system is further operable to process at least a portion of the received signal to identify a repeating request, and if the received signal includes the repeating request, prompt the transceiver to retransmit information corresponding to the received signal.

28. The radio of claim 26, further including a user interface operable to receive an input from a user, the processing system being coupled with the user interface and operable to utilize at least a portion of the user input as the seed value.

29. The radio of claim 26, wherein the processing system is operable to acquire the seed value from an external device.

30. The radio of claim 26, wherein the matrix position corresponds to a channel number matrix having a plurality of columns and rows and the matrix position is identified by—
$$( {x}_{1} , {y}_{1} ) = ( {I}_{L 4} mod \frac{N}{R} , ( {y}_{0} + {I}_{MSD} ) mod R ) ,$$
where (x₁,y₁) is the matrix position, I_{L4} is the least four significant digits of the seed value, N is the number of radio channels, R is the number of rows represented by the channel number matrix, IMSD is the most significant digit of the seed value, and y₀ is an initial row position given by the sum of all digits of the seed value modulo R.

31. The radio of claim 30, wherein the processing system identifies the radio channel by—
Nₓ_{₁}_{,y}_{₁}=((x₁R)+y₁)P mod N,
where N_{x1,y1} is the radio channel associated with matrix position (x₁, y₁), R is the number of rows represented by the channel number matrix, N is the number of radio channels, and P is a randomizing value.

32. The radio of claim 30, wherein the processing system is further operable to identify a plurality of matrix positions by—
$$( {x}_{K} , {y}_{K} ) = ( ( {x}_{K - 1} + 1 ) mod \frac{N}{R} , ( {y}_{0} + {I}_{KMSD} ) mod R ) ,$$
where (xₖ,yₖ) is the Kth matrix position and I_{KMSD} is the Kth most significant digit of the seed value,
the processing system being further operable to identify radio channels corresponding to the identified matrix positions, and
the transceiver being further operable to receive signals at frequencies corresponding to the radio channels.

33. The radio of claim 26, wherein the cyclic code is a (23,12) Golay code.
